(19) United States
(12) Patent Application Publication
(10) Pub. No.: US 2015/0089245 A1
(43) Pub. Date: Mar. 26, 2015

(54) DATA STORAGE IN PERSISTENT MEMORY

(71) Applicants: Asher M. Altman, Bedford, MA (US); Kirk S. Yap, Framingham, MA (US); Raj K. Ramanujan, Federal Way, WA (US)

(72) Inventors: Asher M. Altman, Bedford, MA (US); Kirk S. Yap, Framingham, MA (US); Raj K. Ramanujan, Federal Way, WA (US)

(21) Appl. No.: 14/038,295

(22) Filed: Sep. 26, 2013

(51) Int. Cl. G06F 12/14; G06F 21/60

(52) U.S. Cl. CPC G06F 12/1408; G06F 21/602; G06F 2212/1052
USPC 713/193

(57) ABSTRACT

Embodiments include systems, methods, and apparatuses associated with storing data in a persistent memory are disclosed herein. In embodiments, a memory controller may be configured to encrypt data with an encryption key, and the encrypted data may be stored in persistent memory. The memory controller may be further configured to alter and/or destroy the encryption key in response to a reset event. Other embodiments may be disclosed and/or claimed.

### FIELD

Embodiments of the present invention relate generally to the technical field of memory. Specific embodiments include methods of secure use of persistent (non-volatile) memory to emulate volatile memory.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Presently, computing devices may include one or more pieces of volatile memory, which may be referred to as dynamic random access memory (DRAM) or some other type of volatile memory. Volatile memory may be configured to store data that may be lost upon the occurrence of certain system events. In many cases, these system events may be power-related such as system reset events, system shutdown events, or other system events.

Because the data stored in the volatile memory may be lost or altered upon the occurrence of a system power event, the volatile memory may be well suited to use as system memory. That is, system information, such as information of application like word processing or spreadsheet applications, may be stored on the DRAM while the computing system is operating. In embodiments, the use of volatile memory as system memory may be considered to be relatively secure because the system information that is not to be persistent that is stored in volatile memory may be lost (no longer accessible) upon the occurrence of a system power event.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example memory controller, in accordance with various embodiments.

FIG. 2 illustrates an example process for storing data in persistent memory, in accordance with various embodiments.

FIG. 3 illustrates an example process for decrypting data stored in the persistent memory, in accordance with various embodiments.

FIG. 4 illustrates an example system configured to perform the methods described herein, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Apparatuses, methods, and storage media associated with securely storing data in persistent memory are described herein. Use of persistent memory to store data that may normally be stored in volatile memory may provide greater memory capacities at a lower cost than volatile memory. However, in some cases the persistent memory may retain data in situations where the data would otherwise be lost or destroyed if it was stored in the volatile memory.

In embodiments, a memory controller may be configured to allow persistent memory to emulate volatile memory by securely storing data that may become inaccessible upon the occurrence of a system reset event. Specifically, the memory controller may generate an encryption key, and encrypt data with the encryption key. The encrypted data may then be stored in persistent memory, while the encryption key may be stored in either persistent or volatile memory. In some embodiments, the memory controller may be configured to encrypt, using the encryption key, data already stored in the persistent memory. When the system experiences a reset event such as a system shutdown, restart, or power loss, the encryption key, and/or a decryption key derived from the encryption key, may be altered or destroyed. As a result, even if the encrypted data is retrievable or accessible from the persistent memory, it may not be possible to decrypt the data because the encryption/decryption key may be unavailable. The data storage in the persistent memory may therefore experience the security benefits of storage in volatile memory, while experiencing the benefits of persistent memory such as increased memory capacities at lower cost.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. As used herein, “computer-implemented method” may refer to any method executed by one or more processors, a computer system having one or more processors, a mobile device such as a smartphone (which may include one or more processors), a tablet, laptop computer, a set-top box, a gaming console, and so forth.

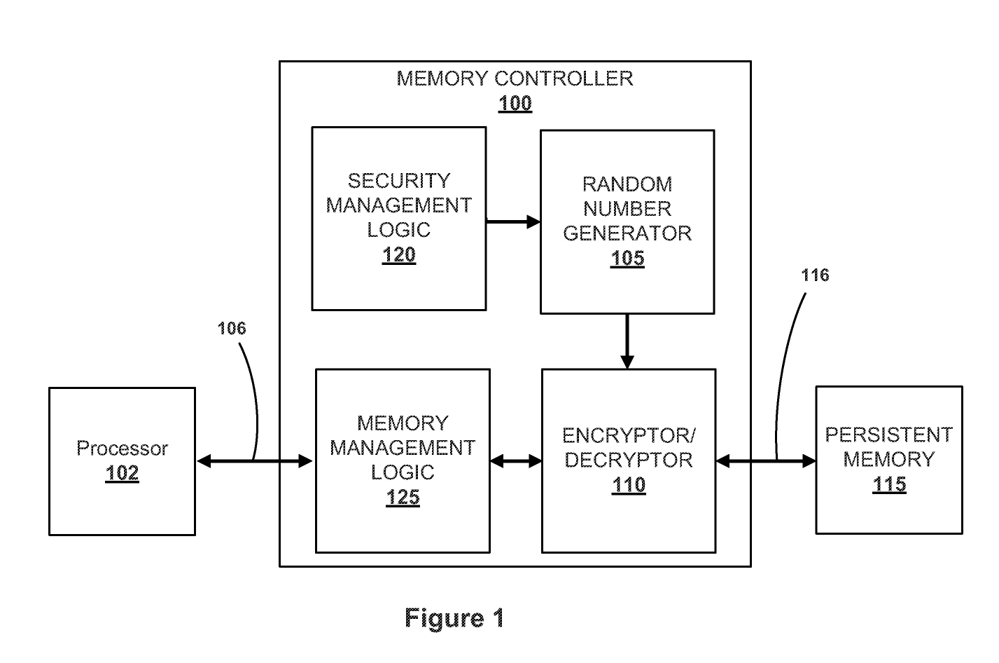

FIG. 1 shows an example of a memory controller 100, which may be coupled to a processor 102 and a persistent memory 115. In some embodiments, the persistent memory 115 may be referred to as a non-volatile memory for example, the persistent memory may be a ferroelectric random access memory (FeTRAM), a nanowire based non-volatile memory, three dimensional (3D) cross point memory such as phase change memory (PCM), a byte-addressable cross point memory, memory that incorporates memristor technology, magnetoresistive random-access memory (MRAM), spin transfer torque (STT) MRAM, or some other type of non-volatile memory which may be used as a system memory. The memory controller 100 may include a random number generator 105. In some embodiments the random number generator 105 may be a digital random number generator or any type of hardware, software, or firmware random number generator. In some embodiments, the random number generator 105 may be configured to generate an advanced encryption standard (AES) key such as a 256 bit AES key pair while in other embodiments the random number generator 105 may be configured to generate a random or pseudorandom number. In some embodiments the random number generator 105 may be a pseudorandom number generator (PRNG) such as a Wichmann-Hill PRNG, a linear feedback shift register, a Mersenne twister, a Naor-Reingold Pseudorandom Function, or some other PRNG. In some embodiments, the random number generator 105 may be a hardware random number generator, otherwise known as a true random number generator (TRNG). A TRNG may be an Araneus Alea TRNG, an entropy key TRNG, or one of a number of different chipsets that are configured to generate a random number. In other embodiments, the random number generator 105 may include one or more cryptographic algorithms such as block ciphers or stream ciphers. The random number generator 105 may additionally or alternatively use other key, random number, or pseudorandom number generation techniques.

The random number generator 105 may be coupled with an encryptor/decryptor 110. The encryptor/decryptor 110 may be an Xor-encrypt-Xor based tweaked-codebook mode with ciphertext stealing AES (XTS-AES) encryptor/decryptor configured to encrypt or decrypt data using an encryption key such as an AES key or 256 bit AES key pair generated by the random number generator 105. Alternatively, the encryptor/decryptor 110 may be configured to receive a random or pseudorandom number from the random number generator 105 and generate a key or key pair, as described above with respect to the random number generator 105. In other embodiments the encryptor/decryptor 110 may use some other type of encryption/decryption algorithm such as AES Liskov Rivest and Wagner (LRW) mode.

The encryptor/decryptor 110 may be further coupled with a persistent memory 115 via one or more communication lines 116. The one or more communication lines 116 may be, for example, referred to as a “memory bus.” As described in further detail below, the encryptor/decryptor 110 or some other element of the memory controller 100 may be configured to encrypt data and output the encrypted data to the persistent memory 115 for storage. In other embodiments, the encryptor/decryptor 110 may be configured to encrypt data that is already stored in the persistent memory 115. In some embodiments, the encryptor/decryptor 110 may be further configured to receive the encrypted data from the persistent memory 115 and decrypt it using the encryption key, or, alternatively, decrypt the encrypted data from the persistent memory 115 without first retrieving the encrypted data from the persistent memory 115.

In embodiments, the memory controller 100 may further include security management logic 120 and/or memory management logic 125. Generally, the security management logic 120 may be coupled with the random number generator 105 and configured to instruct the random number generator 105 to generate and output one or more random numbers or encryption keys. For example, the security management logic 120 may be configured to supply seed values or variables to the random number generator 105.

The memory management logic 125 may be coupled with at least the encryptor/decryptor 110, as well as one or more external communications lines 106. The one or more external communications lines 106 may be a communication line or bus such as a peripheral component interconnect (PCI) or PCI express bus configured to communicatively couple the memory controller 110 to the processor 102. The memory management logic 125 may be configured to receive data to be written into persistent memory 115 from the processor 102 over the external communication lines 106 and then provide the data to the encryptor/decryptor 110. In embodiments, the data may be provided along with encryption instructions from the processor 102, such as, the type of encryption to be performed. The memory management logic 125 may further be configured to export information to the processor 102 via the external communication lines 106. For example, the memory management logic 125 may receive the encryption key used by the encryptor/decryptor 110 from the encryptor/decryptor 110, and then export it to the processor 102 via the external communication lines 106. Additionally or alternatively, the memory management logic 125 may receive decrypted data from the encryptor/decryptor 110, and then export it to the processor 102 via the external communication lines 106.

Additionally or alternatively, as described above, the encryptor/decryptor 110 may be configured to access or retrieve the encrypted data from the persistent memory 115 by way of communication lines 116, and decrypt it using the encryption key employed during the encryption operation (the decryption operation being the inverse of the encryption operation). In some embodiments the encryptor/decryptor 110 may access the encrypted data stored in the persistent memory 115, and decrypt it using the encryption key so that only the decrypted data is transferred over the communication lines 216 to the memory controller 100. In other embodiments, some or all of the encrypted data may be transmitted over the communication lines 116 from the persistent memory to the encryptor/decryptor 110, where the encrypted data is decrypted at the encryptor/decryptor 110 using the encryption key. As an example, the encryption/decryption key, or a random or pseudorandom number used to derive the encryption/decryption key, may be provided by the random number generator 105. Alternatively, the encryption/decryption key may be retrieved by the memory management logic 125 by way of external communication lines 106, for example from a volatile memory coupled with the memory controller 100 by way of external communication lines 106, and supplied to the encryptor/decryptor 110 for encryption/decryption. After the encryptor/decryptor 110 decrypts the encrypted data using the encryption/decryption key, the encryptor/decryptor 110 may output the data to the memory management logic 125 which may then export it to the processor 102 via the one or more communication lines 106. In embodiments, encryptor/decryptor 110 may be configured to alter, destroy, or otherwise lose the encryption/decryption key(s), on reset. In embodiments, the encryptor/decryptor 110 may complementarily derive the decryption key from the encryption key provided by the random number generator 105, or complementarily derive both the encryption and decryption keys from a random number provided by the random number generator 105, as discussed above.

In embodiments, the security management logic 120, the random number generator 105, the encryptor/decryptor 110, and the memory management logic 125 may all be implemented in the memory controller 100 as a system on a chip (SoC) architecture. In other embodiments, one or more of the security management logic 120, the random number generator 105, the encryptor/decryptor 110, and the memory management logic 125 may be separate from, but communicatively coupled to, the memory controller 100. In some embodiments one or more elements such as memory management logic 125 and security management logic 120, or the memory management logic 125 and the encryptor/decryptor 110, may be combined. Alternatively, in some embodiments the encryptor/decryptor 110 may be separated into a separate encryptor and a separate decryptor. As noted above, in some embodiments one or more of the security management logic 120, the random number generator 105, the encryptor/decryptor 110, and the memory management logic 125 may be implemented as software, hardware, and/or firmware.

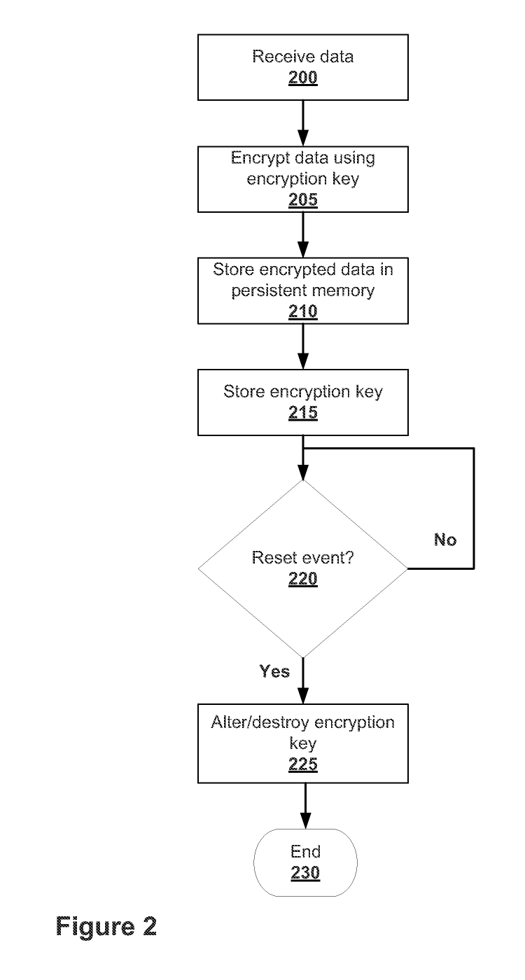

FIG. 2 depicts an example process which may be used by a memory controller such as memory controller 100 to practice embodiments of the present disclosure. Initially, the memory controller may receive data at 200. For example, the data may be received by the memory controller from a processor 102 over communication lines 106, as described above. Specifically, memory management logic such as the memory management logic 125 of memory controller 100 may receive the data over the external communication lines 106.

Next, the memory controller may encrypt the data using an encryption key at 205. For example, an encryptor/decryptor of the memory controller such as encryptor/decryptor 110 of memory controller 100 may receive (or otherwise derive) an encryption key from a random number generator such as random number generator 210505. The encryptor/decryptor may also receive the data from the memory management logic so that the encryptor/decryptor may encrypt it. After encrypting the data, the memory controller may store the encrypted data in persistent memory such as persistent memory 115 at 210. Although not shown, in other embodiments the data may be stored in the persistent memory and then the stored data may be encrypted using the encryption key.

The memory controller may then store the encryption key at 215. In some embodiments, the encryption key may be stored in the persistent memory. For example, the encryption key may be stored in one or more non-sequential registers of the persistent memory such as persistent memory 115. In other embodiments, the encryption key may be transmitted from the memory controller across a communication line to a dynamic random access memory (DRAM) or some other volatile memory.

The memory controller may then monitor for a system reset event at 220. A system reset event may be generally considered to be an event where the contents of volatile memory would normally be lost. As an example, a system reset event may be a loss of power to the system, a system shutdown, a system restart, or some other event. In some embodiments, the system reset event may only be related to portions of a system, for example certain subsections of memory and/or processing elements of the system. The system reset event may be signaled by a platform reset signal received by the memory controller from a processor such as process 102 over communication lines such as communication lines 106. The system reset event may additionally or alternatively be signaled by a notification of a platform power event received by the memory controller from the processor over the communication lines, or by some other type of notification or signal received by the memory controller. In some embodiments, the system reset event may be an event message received by the memory controller. Alternatively, the system reset event may be a signal such as a reset pin, or some other event pin, or a loss of power on one or more power inputs of the memory controller.

If a system reset event is not detected at 220, then the memory controller may continue to monitor for the system reset event. However, if a system reset event is detected, then the memory controller may alter and/or destroy the encryption key at 225. For example, if the encryption key is stored in the persistent memory at 215, then the memory controller may “zeroize” the encryption key in the persistent memory. Zeroizing may include writing values such as all 0's over the memory location of the encryption key one or more times so that the encryption key may not be retrieved from the persistent memory. In other embodiments, the pointers to the memory location of the encryption key may be deleted, or other values such as 1's or a pattern of 0's and 1's may be written to the memory location of the encryption key one or more times. In embodiments where the encryption key is stored in volatile memory, the reset event may cause the encryption key to be lost from the volatile memory. In some embodiments, the encryption key may still be “zeroized” when it is stored in the volatile memory. The process may then end at 230.

At the conclusion of the alteration and/or destruction of the encryption key at 225, the encryption key may be difficult or impossible to retrieve from the memory where the encryption key was stored. Therefore, even if the encrypted data is stored in the persistent memory, it may be difficult or impossible to decrypt the data. As a result, the data may be considered to be secure, and the persistent memory may emulate the security level of volatile memory storage.

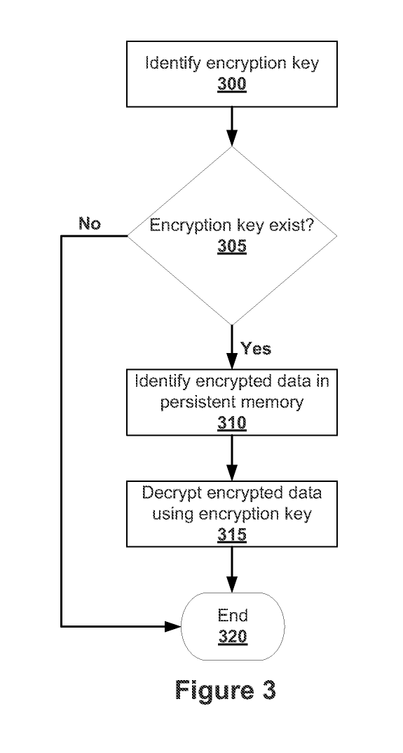

FIG. 3 depicts a process for decrypting data that was encrypted using the process of FIG. 2. The process may be performed by a memory controller such as memory controller 100. Initially, an encryption key may be identified at 300. In embodiments, the encryption key may be identified by memory management logic such as memory management logic 125 and/or an encryptor/decryptor such as encryptor/decryptor 110. As described above, in some embodiments the encryption key may be stored in persistent memory such as persistent memory 115. In other embodiments, the encryption key may be stored in volatile memory that is communicatively coupled with the memory controller.

The memory controller may then determine whether the encryption key exists at 305. In some embodiments, the encryption key may not exist. For example, as described above with reference to FIG. 2, if a system reset event occurred, then the encryption key may have been zeroized, altered, or otherwise deleted. Therefore, the encryption key may not be identifiable, and the process may end at 320. Otherwise, if the encryption key does exist, then the encrypted data may be identified and/or retrieved from persistent memory by the memory controller at 310. Specifically, the encrypted data may be retrieved by one or both of the memory management logic 125 and/or the encryptor/decryptor 110 of the memory controller 100. The encrypted data may then be decrypted by the encryptor/decryptor 110 using the identified encryption key, applying a decryption operation inverse to the decryption operation at 315. In some embodiments, the decrypted data may then be output from the memory controller. The process then ends at 320.

In embodiments, as described earlier, the decryption key may be derived from the encryption key, or from the same random number from which the encryption key is derived. For these embodiments, the process of FIG. 3, may include operations similar to operations at 215 and 220 to destroy or otherwise lose the decryption key.

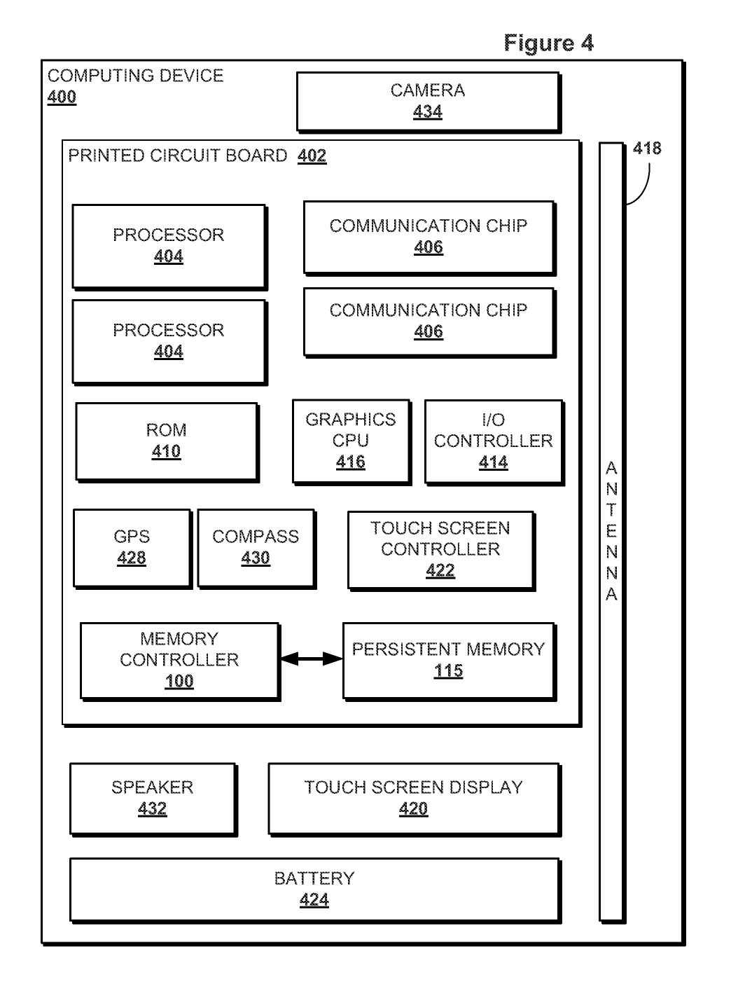

FIG. 4 illustrates an example computing device 400 in which systems such as earlier described memory controller 100 and/or persistent memory 115 may be incorporated, in accordance with various embodiments. Computing device 400 may also include a number of components, one or more processor(s) 404, and at least one communication chip 406. As described earlier, the memory controller 100 may be coupled with a persistent memory 115 which may be configured to emulate a volatile memory by storing encrypted data in the persistent memory 115. Further, the memory controller 100 may be configured to destroy and/or otherwise lose the encryption and/or decryption keys employed to encrypt or decrypt the data.

In various embodiments, the one or more processor(s) 404 each may include one or more processor cores. In various embodiments, the at least one communication chip 406 may be physically and electrically coupled to the one or more processor(s) 404. In further implementations, the communication chip 406 may be part of the one or more processor(s) 404. In various embodiments, computing device 400 may include printed circuit board (PCB) 402. For these embodiments, the one or more processor(s) 404 and communication chip 406 may be disposed thereon. In alternate embodiments, the various components may be coupled without the employment of PCB 402.

Depending on its applications, computing device 400 may include other components that may or may not be physically and electrically coupled to the PCB 402. These other components include, but are not limited to, the memory controller 100, non-volatile memory such as read only memory 410 (ROM), the persistent memory 115, an I/O controller 414, a digital signal processor (not shown), a crypto processor (not shown), a graphics processor 416, one or more antennae 418, a display (not shown), a touch screen display 420, a touch screen controller 422, a battery 424, an audio codec (not shown), a video codec (not shown), a global positioning system (GPS) device 428, a compass 430, an accelerometer (not shown), a gyroscope (not shown), a speaker 432, a camera 434, and a mass storage device (such as hard disk drive, a solid state drive, compact disk (CD), digital versatile disk (DVD))(not shown), and so forth. In various embodiments, the processor 404 may be integrated on the same die with other components to form a System on Chip (SoC). As described above, the persistent memory 115 may be a FeTRAM, a nanowire based non-volatile memory, 3D cross point memory such as PCM, a byte-addressable cross point memory, memory that incorporates memristor technology, MRAM, STT MRAM, or some other type of non-volatile memory which may be used as a system memory.

In various embodiments, in addition to persistent memory 115, computing device 400 may include resident persistent or non-volatile memory, e.g., flash memory (not shown). In some embodiments, the one or more processor(s) 404 and/or flash memory may include associated firmware (not shown) storing programming instructions configured to enable computing device 400, in response to execution of the programming instructions by one or more processor(s) 404 to practice all or selected aspects of the blocks described above with respect to FIG. 2 or 3. In various embodiments, these aspects may additionally or alternatively be implemented using hardware separate from the one or more processor(s) 404 or flash memory.

The communication chips 406 may enable wired and/or wireless communications for the transfer of data to and from the computing device 400. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Bluetooth, derivatives thereof, as well as any other wireless protocols that are designated as 3G, 4G, 5G, and beyond. The computing device 400 may include a plurality of communication chips 406. For instance, a first communication chip 406 may be dedicated to shorter range wireless communications such as Wi-Fi and Bluetooth and a second communication chip 406 may be dedicated to longer range wireless communications such as GPS, EDGE, GPRS, CDMA, WiMAX, LTE, Ev-DO, and others.

In various implementations, the computing device 400 may be a laptop, a netbook, a notebook, an ultrabook, a smartphone, a computing tablet, a personal digital assistant (PDA), an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 400 may be any other electronic device that processes data.

In embodiments, a first example of the present disclosure may include an apparatus to alter an encryption key, the apparatus comprising: a memory controller configured to alter or destroy, in response to a reset event, an encryption key employed to encrypt a data before storage of the data in a persistent memory, wherein the persistent memory is controlled by the memory controller.

Example 2 may include the apparatus of example 1, further comprising the persistent memory, coupled with the memory controller.

Example 3 may include the apparatus of example 1, further comprising a storage memory configured to store the encryption key.

Example 4 may include the apparatus of example 3, wherein the storage memory comprises a volatile memory coupled with the memory controller.

Example 5 may include the apparatus of example 3, wherein the storage memory includes a plurality of non-sequential registers of the persistent memory, and the encryption key is stored in one or more of the plurality of non-sequential registers.

Example 6 may include the apparatus of any of examples 1-5, wherein the memory controller is configured to zero the encryption key to destroy the encryption key.

Example 7 may include the apparatus of any of examples 1-5, wherein the memory controller is further configured to alter or destroy a decryption key, complementary to the encryption key, in response to the reset event.

Example 8 may include the apparatus of any of examples 1-5, wherein the reset event includes a power loss event, a shutdown event, or a restart event.

Example 9 may include a method to store encrypted data, the method comprising: encrypting, by a memory controller, a data based at least in part on an encryption key to create an encrypted data; storing, by the memory controller, the encrypted data in a nonvolatile memory; receiving, by the memory controller, an indication of a reset event; and destroying, by the memory controller, the encryption key in response to receiving the indication of the reset event.

Example 10 may include the method of example 9, wherein destroying comprises overwriting the encryption key.

Example 11 may include the method of example 9, wherein destroying comprises zeroizing the encryption key.

Example 12 may include the method of any of examples 9-11, wherein destroying further comprises destroying a decryption key, complementary to encryption key, in response to the reset event.

Example 13 may include the method of any of examples 9-11, wherein the reset event is a power loss event, a shutdown event, or a restart event.

Example 14 may include one or more computer readable media comprising instructions to destroy an encryption key, the instructions configured, upon execution of the instructions by a memory controller, to cause the memory controller to: receive an indication of a reset event; and destroy, in response to the indication of the reset event, an encryption key employed to encrypt a data before storage of the data in a persistent memory controlled by the memory controller.

Example 15 may include the one or more computer readable media of example 14, wherein the memory controller is caused to destroy the encryption key.

Example 16 may include the one or more computer readable media of example 14, wherein the memory controller is caused to zeroize the encryption key to destroy the encryption key.

Example 17 may include the one or more computer readable media of any of examples 14-16, wherein the memory controller is caused to decrypt the encrypted data with the encryption key or a decryption key complementary to the encryption key.

Example 18 may include the one or more computer readable media of any of examples 14-16, wherein the memory controller is further caused to destroy a decryption key, complementary to the encryption key, in response to the reset event.

Example 19 may include the one or more computer readable media of any of examples 14-16, wherein the reset event is a power loss event, a shutdown event, or a restart event.

Example 20 may include an apparatus to destroy an encryption key, the apparatus comprising: means to receive an indication of a reset event; and means to destroy, in response to the indication of the reset event, an encryption key employed to encrypt a data before storage of the data in a persistent memory.

Example 21 may include the apparatus of example 20, wherein the means to destroy include means to zeroize the encryption key to destroy the encryption key.

Example 22 may include the apparatus of examples 20 or 21 further comprising means to decrypt the encrypted data with the encryption key or a decryption key complementary to the encryption key.

Example 23 may include the apparatus of examples 20 or 21, further comprising means to destroy a decryption key, complementary to the encryption key, in response to the reset event.

Example 24 may include the apparatus of examples 20 or 21, wherein the reset event is a power loss event, a shutdown event, or a restart event.

Example 25 may include a system comprising: a persistent memory configured to store an encrypted data; a memory controller coupled with the persistent memory and configured to: receive an indication of a reset event; and destroy, in response to the indication of the reset event, an encryption key employed to encrypt the encrypted data before storage of the encrypted data in the persistent memory.

Example 26 may include the system of example 25, wherein the memory controller is further configured to zeroize the encryption key to destroy the encryption key.

Example 27 may include the system of examples 25 or 26, wherein the memory controller is further configured to decrypt the encrypted data with the encryption key or a decryption key complementary to the encryption key.

Example 28 may include the system of examples 25 or 26, wherein the memory controller is further configured to destroy a decryption key, complementary to the encryption key, in response to the reset event.

Example 29 may include the system of examples 25 or 26, wherein the reset event is a power loss event, a shutdown event, or a restart event.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus comprising:
a memory controller configured to alter or destroy, in response to a reset event, an encryption key employed to encrypt a data before storage of the data in a persistent memory, wherein the persistent memory is controlled by the memory controller.

2. The apparatus of claim 1, further comprising the persistent memory, coupled with the memory controller.

3. The apparatus of claim 1, further comprising a storage memory configured to store the encryption key.

4. The apparatus of claim 3, wherein the storage memory comprises a volatile memory coupled with the memory controller.

5. The apparatus of claim 3, wherein the storage memory includes a plurality of non-sequential registers of the persistent memory, and the encryption key is stored in one or more of the plurality of non-sequential registers.

6. The apparatus of claim 1, wherein the memory controller is configured to zero the encryption key to destroy the encryption key.

7. The apparatus of claim 1, wherein the memory controller is further configured to alter or destroy a decryption key, complementary to the encryption key, in response to the reset event.

8. The apparatus of claim 1, wherein the reset event includes a power loss event, a shutdown event, or a restart event.

9. A method comprising:
encrypting, by a memory controller, a data based at least in part on an encryption key to create an encrypted data;
storing, by the memory controller, the encrypted data in a nonvolatile memory;
receiving, by the memory controller, an indication of a reset event; and
destroying, by the memory controller, the encryption key in response to receiving the indication of the reset event.

10. The method of claim 9, wherein destroying comprises overwriting the encryption key.

11. The method of claim 9, wherein destroying comprises zeroizing the encryption key.

12. The method of claim 9, wherein destroying further comprises destroying a decryption key, complementary to encryption key, in response to the reset event.

13. The method of claim 9, wherein the reset event is a power loss event, a shutdown event, or a restart event.

14. A system comprising:
a persistent memory configured to store an encrypted data;
a memory controller coupled with the persistent memory and configured to:
receive an indication of a reset event; and
destroy, in response to the indication of the reset event, an encryption key employed to encrypt the encrypted data before storage of the encrypted data in the persistent memory.

15. The system of claim 14, wherein the memory controller is further configured to zeroize the encryption key to destroy the encryption key.

16. The system of claim 14, wherein the memory controller is further configured to decrypt the encrypted data with the encryption key or a decryption key complementary to the encryption key.

17. The system of claim 14, wherein the memory controller is further configured to destroy a decryption key, complementary to the encryption key, in response to the reset event.

18. The system of claim 14, wherein the reset event is a power loss event, a shutdown event, or a restart event.
